(19) United States
(12) Patent Application Publication
(10) Pub. No.: US 2003/0233756 A1
(43) Pub. Date: Dec. 25, 2003

(54) Device for edge cutting of strips of material

(76) Inventor: Moritz Muhlebach, Dietlikon (CH)

Correspondence Address: HORST KASPER, 13 FOREST DRIVE, WARREN, NJ, 07059, US

(21) Appl. No.: 10/387,899

(22) Filed: Mar. 13, 2003

(30) Foreign Application Priority Data
Jun. 22, 2002 (DE) 202 09 726.9

(51) Int. Cl. B26B 13/00; A01D 1/00

(52) U.S. Cl. 30/265; 30/279.2

(57) ABSTRACT

The device for edge cutting of strips of material includes a groove (2) disposed in a base body (1) and passing through over the length of the base body (1) and exhibiting in each case a round blade (6) at sideways protruding arms (4) and (5) at the lower open end of the groove (2). The round blades (6) are disposed somewhat staggered relative to the longitudinal axis of the groove (2). The round blade (6) disposed in the arm (5) is disposed somewhat inclined under an angle relative to the wall of the groove (2). The round blade (6) disposed in the arm (5) separates at an angle the downwardly disposed region of the strip of material in order to generate a so-called undercut, whereby the laying work and installation can be performed more exact and simpler.

### BACKGROUND OF THE INVENTION

1. Field of the Invention

The invention relates to a device for a cutting of strips of material such as floor covering or edge plinths with blades disposed opposite each other at the outer edge of a groove extending through a base body for receiving strips of material. The strips of material or webs of material can comprise a carpet, linoleum, polyvinyl chloride PVC, CV, or fleece covering.

2. Brief Description of the Background of the Invention Including Prior Art

Known edge cutters of this kind serve to cut off the fabrication edge of such a strip of material, where the fabrication edge during rolling up to the end edge can exhibit not overall the same thickness, in order to enable a clean and flush precise following to each other of strips of material during laying. Known edge cutters of this kind are furnished with a passing through groove for receiving the edge of the strip of material and two tipped ground blades disposed standing opposite to each other and formed like a knife, wherein the blades separate the strip of material with a straight cut from the bottom side and from the top side of the strip of material. However, the laying work becomes cleaner and simpler if a so-called undercut can be produced at the bottom side of the strip of material, wherein the bottom side of the material can have very different thicknesses, that is a lower part region of the strip of material is separated at an inclined angle such that two strips abutting each other exhibit at the bottom side a wedge shape hollows space in the joint gap and wherein the strips only in the upper part region close up flush to each other. Various floor coverings exhibit a jute fabric on the bottom side, which very much interferes in the abutting gap in cases where the jute fabric is not cut back with the recited undercut.

Conventional edge cutters of this kind are further furnished with a groove with a fixed width of groove for receiving of thick as well as thin strips of material. The edge cutting becomes already cumbersome and not very precise in the latter case with correspondingly much play in the groove.

### SUMMARY OF THE INVENTION

### 1. PURPOSES OF THE INVENTION

It is an object of the present invention to furnish a device for edge cutting of strips of material in order to achieve a more precise and simultaneously easier working during laying of strips of material with the aid of an undercut and in order to be able to process uniformly well and clean in addition strips of material of very different strength.

These and other objects and advantages of the present invention will become evident from the description which follows.

### 2. BRIEF DESCRIPTION OF THE INVENTION

A device for edge cutting of strips of material such as floor coverings or edge plinths is furnished, which includes a base body, a groove formed in the base body and extending through the base body and for receiving a strip of material, a first round blade disposed at a first outer edge of the groove, wherein the first round blade is disposed perpendicular at an angle of 90 degrees to a wall of the groove, a second round blade disposed at a second outer edge of the groove, wherein the second round blade is disposed inclined under an angle of less than 90 degrees relative to the wall of the groove for generating of an undercut extending over a part region of the thickness of the strip of material, wherein the first round blade is disposed opposite to the second round blade and slightly staggered relative to the longitudinal axis of the groove, and wherein the first round blade is disk-shaped and has its center attached to the base body with a first screw, and wherein the second round blade is disk-shaped and has its center attached to the base body with a second screw.

Material in the context of the present invention is any two dimensional structure subject to being cut. Material includes carpets, indoor-outdoor carpets, vinyl tiles, linoleum, fabric tiles, vinyl foil, plastic coverings, paper and cardboard products.

The second round blade is preferably disposed inclined under an angle from about 75 to 80 degrees relative to the wall of the groove. The second round blade is preferably further disposed away from the handle as compared to the first blade. A line connecting the center of the first blade with the center of the second blade in projection onto the planer of the first blade forms an angle of from about 50 to 70 degrees with an axis of the groove. The diameter of the round blade can be from about 3 to 5 times the inner width of the groove. The length of the groove can be from 10 to 30 times the inner width of the groove. The inner depth of the groove can be from about 3 to 10 times the inner width of the groove and is preferably from about 4 to 6 times the inner width of the groove.

A third round blade can be disposed at the first outer edge of the groove, wherein the third round blade is disposed perpendicular at an angle of 90 degrees to the wall of the groove. A fourth round blade can be disposed at the second outer edge of the groove, wherein the fourth round blade is disposed inclined under an angle of less than 90 degrees relative to the wall of the groove for generating of an undercut extending over a part region of the thickness of the strip of material, wherein the third round blade is disposed opposite to the fourth round blade and slightly staggered relative to the longitudinal axis of the groove, and wherein the third round blade is disk-shaped and has its center attached to the base body with a third screw, and wherein the fourth round blade is disk-shaped and has its center attached to the base body with a fourth screw.

Preferably, the first round blade and the third round blade are disposed mirror like at two sides of a middle handle part for the device being capable of use by left-handed persons or by right-handed persons, and the second round blade and the fourth round blade are disposed mirror like at two sides of the middle handle part (3) for the device being capable of use by left-handed persons or by right-handed persons.

The first-round blade can be disposed fixed against rotation in a first arm of the base body with a first clamping screw in a first elongated hole of the first arm for adjusting the distance to the middle of the groove. The second round blade can be disposed fixed against rotation in a second arm of the base body with a second clamping screw in a second elongated hole of the second arm for adjusting the distance to the middle of the groove. Preferably, the first round blade and the second round blade are disposed opposite to each other and are disposed staggered to each other relative to the longitudinal axis of the groove for avoiding a mutual touching of the first round blade and of the second round blade in the area of the middle of the groove.

Inserts of different width and depth for insertion of the strip of material can be provided, wherein the inserts are attachable with a clamping screw in the groove for adapting the groove to the thickness of the strip of material to be processed and depending if a narrow edge strip or a wide edge strip is to be cut off.

An insert can be of substantially uniform thickness and can be covering an inside surface of the groove substantially completely. An insert can be of substantially uniform thickness and can be covering a floor of the groove substantially completely for uniformly reducing the depth of the groove.

Inserts can be attachable with a clamping screw in the groove for reducing the depth of the groove or for reducing the width of the groove for depth gain to the respective thickness of the strip of material.

A hollow space can be formed in the middle handle part following behind the groove and of about the size of the groove and can be serving as a closable compartment for blades for receiving of substitute blades. A removable cover can be provided for the hollow space. The length of the groove can be from about 2 to 4 times the length of the hollow space in the direction parallel to a longitudinal axis of the groove.

A method is furnished for edge cutting of strips of material such as floor coverings or edge plinths. A base body having a groove passing through the base body and extending through the base body can be formed and for receiving a strip of material. A center of a first round blade can be attached at a first outer edge of the groove with a first screw, wherein the first round blade is disposed perpendicular at an angle of 90 degrees to a wall of the groove, and wherein the first round blade is disk-shaped. A center of a second round blade can be attached at a second outer edge of the groove with a second screw, wherein the second round blade is disposed inclined under an angle of less than 90 degrees relative to the wall of the groove for generating of an undercut extending over a part region of the thickness of the strip of material, wherein the first round blade is disposed opposite to the second round blade and slightly staggered relative to the longitudinal axis of the groove, and wherein the second round blade is disk-shaped. The base body can be pulled along relative to an edge of the strip of material such that the edge of material passes through the groove.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

In the accompanying drawing, in which are shown several of the various possible embodiments of the present invention:

FIG. 1 is a bottom review of the device with round blades at two sides of a groove,

FIG. 2 is a side elevational view of the device,

FIG. 3 is a section through the device according to section line 1-2 in FIG. 2,

FIG. 4 is a section through the device according to FIG. 3 with an insert in the groove and showing the production of the undercut at the strip of material based on the inclined disposed blade,

FIG. 5a is a schematic sectional view of a first insert to be fixedly clamped in the groove of a shape of a U having a thick bottom,

FIG. 5b is a schematic sectional view of a second insert to be fixedly clamped in the groove of a shape of an L having a thick bottom,

FIG. 5c is a schematic sectional view of a third insert to be fixedly clamped in the groove of a shape of an L having a thin bottom,

FIG. 5d is a schematic sectional view of a fourth insert to be fixedly clamped in the groove having a shape of a U having a thin bottom,

FIG. 5e is a schematic sectional view of a fifth insert to be fixedly clamped in the groove having the shape of a bar,

FIG. 6 is a production of an undercut at two strips of material adjoining each other with inclined disposed round blades.

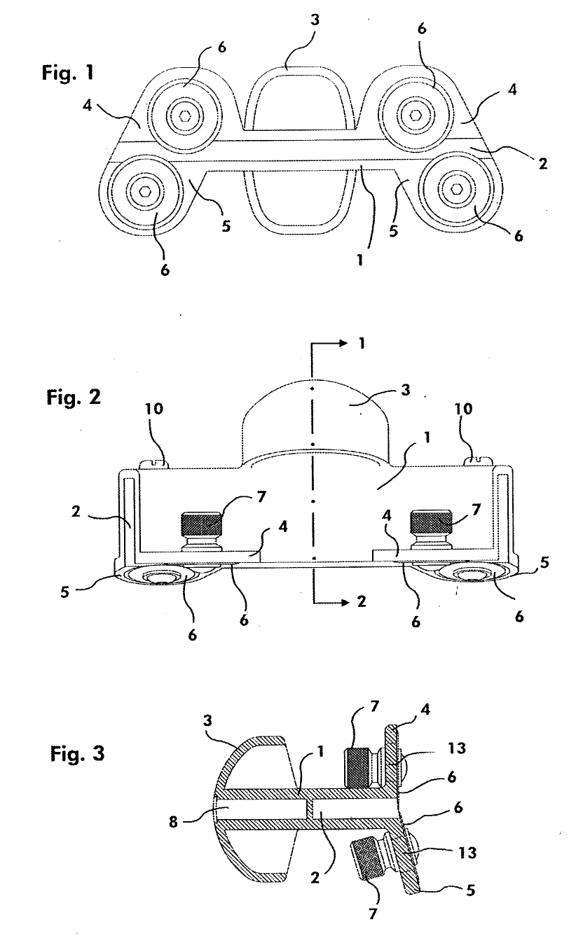

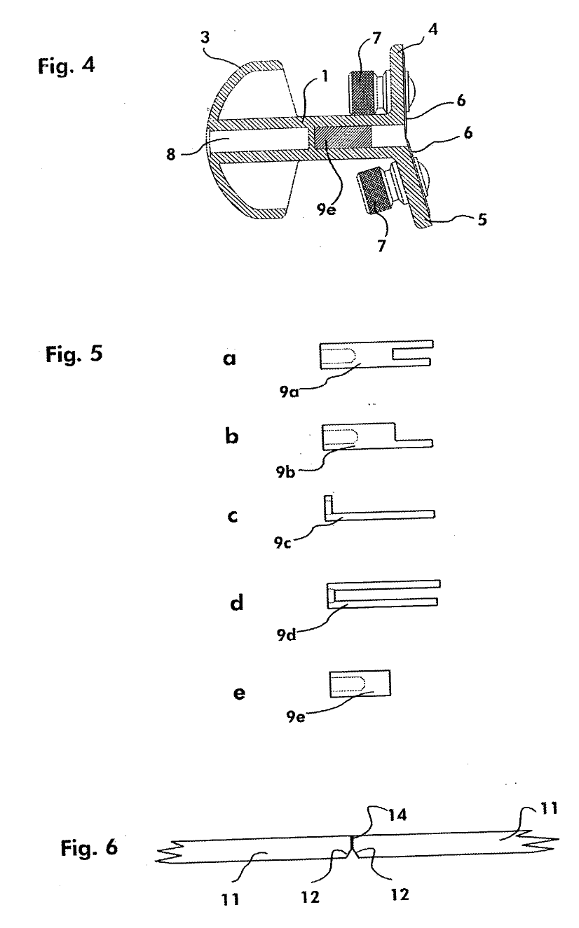

### DESCRIPTION OF INVENTION AND PREFERRED EMBODIMENT

The device exhibits the base body 1, wherein a groove 2 open to the bottom side of the base body 1 extends through the base body 1 over the full-length of the base body. The groove 2 forms an elongated channel in the base body 1. The groove 2 exhibits a U-shaped cross section. A handle 3 is formed in the middle region of the base body 1. The handle 3 can be attached to the groove 2 by extending the arms of the U-shaped cross section at the bottom of the U in the area of the handle 3 thereby creating an H-shaped cross section in the area of the handle 3. The upper end of the H has attached a part for gripping the edge cutter, wherein said part has a shape of a semi sphere or topologically equivalent to a semi sphere. The upper end of the H can have a door or flap for enclosing the space 8 and for allowing opening of the space 8.

At two sides of the handle 3, there are two outwardly perpendicular protruding arms 4 provided on one side of the open end of the groove 2 and two outwardly at a slight angle protruding arms 5 disposed inclined relative to the groove on an opposite side of the open end of the groove 2. The outwardly protruding arms 4 form with the wall of the groove an angle of 90 degrees. The plane of the outer side of the arm 5 forms an angle of less than 90 degrees with the wall of the groove and preferably an angle from about 75 to 80 degrees. Round blades 6 formed in the same way are fixedly supported with a knurled screw 7 in the four arms 4 and 5 of the base body 1, wherein the round blades 6 do not rotate but are capable of being adjusted with a multiple cornered axis of the knurled screw, and thereby always a new sharp region becomes effective for cutting. The round blades cut very much better as compared with the knife shaped blades employed in conventional edge cutters.

Elongated slots or holes 13 are formed in the arms 4 and 5 for receiving the knurled knob7 for allowing to adjust the position of the round blades relative to the middle of the groove and therewith round blades disposed opposite to each other do not contact at the middle position of the groove and for this reason, the round blades are disposed somewhat staggered relative to the longitudinal axis of the groove.

The round blades 6 are disposed slightly staggered relative to each other with respect to the longitudinal axis of the groove 2. The round blade 6 disposed in the arm 4 cuts in the upper region of the strip of material 11 according to FIG. 6, while the round blade disposed in the arm 5 cuts through the lower region of the strip of material in order to produce the undercut 12. In case two strips of material cut in this manner abut to each other, then a wedge shaped hollow space is generated below at the abutting joint gap 14. Based on this method, strips of material can be laid cleaner and more easy, for example, a bottom side jute fabric is cut back at the strip of material.

The round blades 6 disposed mirror like relative to the middle handle part 3 and disposed in each case like pairs opposite to each other are twice present in this device, in order to allow left-handed persons as well as right-handed persons to work with the device in each suitable position. The double disposition of the round blade pairs is required only based on the inclined position of the one round blade, whereas known edge cutters with one straight knife shaped pair of blades can be used by right-handed persons as well as by left-handed persons.

A hollow space 8 is furnished in the middle of the middle handle part 3 serving as a compartment for receiving replacement blades, wherein the hollow space 8 follows to the groove 2 and is approximately of the same size as is the groove 2.

In order to be able to process with the uniform quality and precisely strips of material with the different thicknesses, various inserts 9a through 9e are furnished according to FIGS. 5a through 5e having the purpose of providing and of making available different groove depths and/or groove widths for the strips of material to be processed. The inserts 9a through 9e can be attached in the groove 2 with a clamping screw 10.

It will be understood that each of the elements described above, or two or more together, may also find a useful application in other types of cutting system configurations and edge cutting procedures differing from the types described above.

While the invention has been illustrated and described as embodied in the context of a device for edge cutting of strips of material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for edge cutting of strips of material such as floor coverings or edge plinths, having blades at the outer edge of a groove extending through a base body and for receiving a strip of material, wherein a first round blade (6) is disposed perpendicular at an angle of 90 degrees to the wall of the groove and a second round blade (6) is disposed inclined under an angle of less than 90 degrees relative to the wall of the groove for generating of an undercut extending over a part region of the thickness of the strip of material, wherein the first round blade (6) is disposed opposite to the second round blade (6) and slightly staggered relative to the longitudinal axis of the groove (2), and wherein the first round blade (6) is disk-shaped and has its center attached to the base body-with a screw, and wherein the second round blade (6) is disk-shaped and has its center attached to the base body with a screw.

2. The device according to claim 1, wherein the second round blade is disposed inclined under an angle from about 75 to 80 degrees relative to the wall of the groove.

3. The device according to claim 1, wherein the first round blade and the second round blade forms a round blade pair, wherein the base body (1) exhibits round blade pairs attached to the base body, wherein the round blade pairs are in each case slightly staggered disposed opposite to each other and are disposed mirror like at two sides of a middle handle part (3) for the device being capable of use by left-handed persons or by right-handed persons.

4. The device according to claim 1,
wherein the first round blade is disposed fixed against rotation in a first arm (4) of the base body (1) with a first clamping screw (7) in a first elongated hole (13) of the first arm (4)for adjusting the distance to the middle of the groove (2), and
wherein the second round blade (6) is disposed fixed against rotation in a second arm (5) of the base body (1) with a second clamping screw (7) in a second elongated hole (13) of the second arm (5) for adjusting the distance to the middle of the groove (2),
wherein the first round blade (6) and the second round blade (6) are disposed opposite to each other and are disposed staggered to each other relative to the longitudinal axis of the groove (2) for avoiding a mutual touching of the first round blade (6) and of the second round blade (6) in the area of the middle of the groove (2).

5. The device according to claim 1 further comprising inserts (9a through 9e) of different width and depth for insertion of the strip of material, wherein the inserts (9a through 9e) are attachable with a clamping screw (10) in the groove (2) for adapting the groove (2) to the thickness of the strip of material to be processed and depending if a narrow edge strip or a wide edge strip is to be cut off.

6. The device according to claim 1 further comprising inserts (9a through 9e) attachable with a clamping screw (10) in the groove (2) for reducing the depth of the groove or for reducing the width of the groove for depth gain to the respective thickness of the strip of material.

7. The device according to claim 3 further comprising a hollow space formed in the middle handle part (3) following behind the groove (2) and of about the size of the groove (2) and serving as a closable compartment (8) for blades for receiving of substitute blades.

8. A device for edge cutting of strips of material such as floor coverings or edge plinths comprising
a base body (1);
a groove (2) formed in the base body (1) and extending through the base body (1) and for receiving a strip of material;
a first round blade disposed at a first outer edge of the groove, wherein the first round blade (6) is disposed perpendicular at an angle of 90 degrees to a wall of the groove;
a second round blade disposed at a second outer edge of the groove, wherein the second round blade (6) is disposed inclined under an angle of less than 90 degrees relative to the wall of the groove for generating of an undercut extending over a part region of the thickness of the strip of material, wherein the first round blade (6) is disposed opposite to the second round blade (6) and slightly staggered relative to the longitudinal axis of the groove (2), and wherein the first round blade (6) is disk-shaped and has its center attached to the base body with a first screw, and wherein the second round blade (6) is disk-shaped and has its center attached to the base body with a second screw.

9. The device according to claim 8, wherein the second round blade is disposed inclined under an angle from about 75 to 80 degrees relative to the wall of the groove.

10. The device according to claim 8 further comprising
a third round blade disposed at the first outer edge of the groove, wherein the third round blade (6) is disposed perpendicular at an angle of 90 degrees to the wall of the groove;
a fourth round blade at the second outer edge of the groove, wherein the fourth round blade (6) is disposed inclined under an angle of less than 90 degrees relative to the wall of the groove for generating of an undercut extending over a part region of the thickness of the strip of material, wherein the third round blade (6) is disposed opposite to the fourth round blade (6) and slightly staggered relative to the longitudinal axis of the groove (2), and wherein the third round blade (6) is disk-shaped and has its center attached to the base body with a third screw, and wherein the fourth round blade (6) is disk-shaped and has its center attached to the base body with a fourth screw;
wherein the first round blade and the third round blade are disposed mirror like at two sides of a middle handle part (3) for the device being capable of use by left-handed persons or by right-handed persons;
wherein the second round blade and the fourth round blade are disposed mirror like at two sides of the middle handle part (3) for the device being capable of use by left-handed persons or by right-handed persons.

11. The device according to claim 8,
wherein the first round blade is disposed fixed against rotation in a first arm (4) of the base body (1) with a first clamping screw (7) in a first elongated hole (13) of the first arm (4) for adjusting the distance to the middle of the groove (2), and
wherein the second round blade (6) is disposed fixed against rotation in a second arm (5) of the base body (1) with a second clamping screw (7) in a second elongated hole (13) of the second arm (5) for adjusting the distance to the middle of the groove (2),
wherein the first round blade (6) and the second round blade (6) are disposed opposite to each other and are disposed staggered to each other relative to the longitudinal axis of the groove (2) for avoiding a mutual touching of the first round blade (6) and of the second round blade (6) in the area of the middle of the groove (2).

12. The device according to claim 8 further comprising
inserts (9a through 9e) of different width and depth for insertion of the strip of material, wherein the inserts (9a through 9e) are attachable with a clamping screw (10) in the groove (2) for adapting the groove (2) to the thickness of the strip of material to be processed and depending if a narrow edge strip or a wide edge strip is to be cut off.

13. The device according to claim 8 further comprising
an insert (9d) of substantially uniform thickness and covering an inside surface of the groove (2) substantially completely.

14. The device according to claim 8 further comprising
an insert (9e) of substantially uniform thickness and covering a floor of the groove (2) substantially completely for uniformly reducing the depth of the groove (2).

15. The device according to claim 8 further comprising
inserts (9a through 9e) attachable with a clamping screw (10) in the groove (2) for reducing the depth of the groove or for reducing the width of the groove for depth gain to the respective thickness of the strip of material.

16. The device according to claim 10 further comprising
a hollow space formed in the middle handle part (3) following behind the groove (2) and of about the size of the groove (2) and serving as a closable compartment (8) for blades for receiving of substitute blades.

17. A method for edge cutting of strips of material such as floor coverings or edge plinths comprising
forming a base body (1) having a groove (2) passing through the base body (1) and extending through the base body (1) and for receiving a strip of material;
attaching a center of a first round blade at a first outer edge of the groove with a first screw, wherein the first round blade (6) is disposed perpendicular at an angle of 90 degrees to a wall of the groove, and wherein the first round blade (6) is disk-shaped; attaching a center of a second round blade at a second outer edge of the groove with a second screw, wherein the second round blade (6) is disposed inclined under an angle of less than 90 degrees relative to the wall of the groove for generating of an undercut extending over a part region of the thickness of the strip of material, wherein the first round blade (6) is disposed opposite to the second round blade (6) and slightly staggered relative to the longitudinal axis of the groove (2), and wherein the second round blade (6) is disk-shaped;
pulling the base body along relative to an edge of the strip of material such that the edge of material passes through the groove (2).
